(19) United States
(12) Patent Application Publication
(10) Pub. No.: US 2025/0332951 A1
(43) Pub. Date: Oct. 30, 2025

(54) BATTERY EXCHANGE SYSTEM FOR ELECTRIC VEHICLE

(71) Applicant: ISUZU MOTORS LIMITED, Yokohama-shi (JP)

(72) Inventors: Jun HOMMA, Fujisawa-shi (JP); Yuki TEMMA, Fujisawa-shi (JP); Masahiro SEKITA, Fujisawa-shi (JP); Teppei TSUCHIYA, Fujisawa-shi (JP); Kazuhiro UEDA, Fujisawa-shi (JP); Takashi MIZUKI, Fujisawa-shi (JP); Takahiro SEKIUCHI, Fujisawa-shi (JP); Yuta ICHINOSE, Fujisawa-shi (JP); Kento MATSUSHITA, Fujisawa-shi (JP)

(21) Appl. No.: 19/057,933

(22) Filed: Feb. 19, 2025

(30) Foreign Application Priority Data
Apr. 30, 2024 (JP) 2024-073911

(51) Int. Cl. B60L 53/80; B60L 58/20; H01M 50/249

(52) U.S. Cl. CPC B60L 53/80; B60L 58/20; H01M 50/249; H01M 2220/20

(57) ABSTRACT

Battery 11 exchange system 1 for electric vehicle C according to the present disclosure includes: lock mechanism 13 configured to attach battery 11 to vehicle frame Cf; on-board actuator 14 configured to drive lock mechanism 13 to switch between a locked state and an unlocked state of battery 11 with respect to vehicle frame Cf; on-board circuit network 20 configured to operate on-board actuator 14; on-board controller 100 configured to control an operation of on-board actuator 14 via on-board circuit network 20; and on-board connector 21, one end of which is connected to on-board circuit network 20 and the other end of which is connectable to external controller 200. When on-board controller 100 is in a non-operating state, the operation of on-board actuator 14 is controllable by external controller 200 via on-board circuit network 20.

### CROSS REFERENCE TO RELATED APPLICATIONS

This application claims the benefit of priority of Japanese Patent Application No. 2024-073911, filed Apr. 30, 2024, the contents of which are incorporated herein by reference in their entirety.

### TECHNICAL FIELD

The present disclosure relates to a battery exchange system for an electric vehicle.

### BACKGROUND ART

In the related art, electric vehicles (for example, electric automobiles and electric scooters) equipped with batteries are known.

In recent years, the electric vehicles of this type have increasingly used battery exchange systems. Such battery exchange systems are incorporated in a vehicle based on the concept that when the storage power of the battery mounted on a vehicle is depleted, the battery is exchanged with another battery fully charged at a battery exchange station, instead of charging the battery each time (see, for example, PTL 1, which is a prior application by the applicant of the present application).

### CITATION LIST

### Patent Literature

### PTL 1

Japanese Patent Application No. 2023-134543

### SUMMARY OF INVENTION

### Technical Problem

This type of battery exchange system removes the battery from the vehicle frame and/or attaches the battery to the vehicle frame by controlling the operation of a lock mechanism (for example, see FIGS. 4 and 5 described later) that supports and fixes the battery to the vehicle frame under the control of an on-board controller.

As such, when the on-board controller is in a non-operating state for some reason, the lock mechanism cannot be activated, which makes it very difficult to remove the battery from the vehicle frame or attach the battery to the vehicle frame. In general, the lock mechanism firmly fixes the battery to the vehicle frame for safety reasons. To remove the battery from the vehicle frame by disassembling the lock mechanism, it is necessary to lower the vehicle's body (i.e., the cargo bed) and remove the peripheral components of the battery attached to the vehicle frame.

This type of battery exchange system typically operates at a battery exchange station, and exchanges the battery mounted on a vehicle in conjunction with a robot or the like on the battery exchange station side after establishing communication with a station system on the battery exchange station side. At this time, the on-board controller transmits, to the station system, current position information of the vehicle, information on the battery to be exchanged among the plurality of battery packs mounted on the vehicle, and the like, for example.

Under such circumstances, the function of activating the lock mechanism of the on-board controller is typically set to a non-operating state except in the battery exchange station for safety reasons and the like.

However, in actual use of a vehicle, it may be necessary to exchange the battery or temporarily attach/detach the battery in a location other than a battery exchange station, such as when the storage power of the battery is depleted or when repair of the on-board device is required due to a failure of the vehicle on the road. Further, in case of a vehicle accident, the on-board controller itself may become completely non-operational.

In such a case, the current battery exchange system cannot activate the lock mechanism, which makes it extremely difficult to remove the battery from the vehicle frame or attach the battery to the vehicle frame as described above.

The present disclosure has been made in view of the above problems, and an object thereof is to provide a battery exchange system for an electric vehicle that activates a lock mechanism and allows attachment/detachment of a battery even when an on-board controller is in a non-operating state.

### Solution to Problem

To solve the above-described problems, a battery exchange system according to the present invention is a system for an electric vehicle, including: a lock mechanism fixed to a vehicle frame of the electric vehicle and configured to attach a battery to the vehicle frame; an on-board actuator configured to drive the lock mechanism to switch between a locked state and an unlocked state of the battery with respect to the vehicle frame; an on-board circuit network configured to operate the on-board actuator; an on-board controller configured to control an operation of the on-board actuator via the on-board circuit network; and an on-board connector, one end of which is connected to the on-board circuit network and the other end of which is connectable to an external controller. When the on-board controller is in a non-operating state, the operation of the on-board actuator is controllable by the external controller via the on-board circuit network.

### Advantageous Effects of Invention

According to the battery exchange system of the present invention, it is possible to activate the lock mechanism and attach/detach the battery even when the on-board controller is in a non-operating state.

### BRIEF DESCRIPTION OF DRAWINGS

FIG. 1 is a diagram illustrating an example of various on-board devices attached to a vehicle frame of a vehicle;

FIG. 2 is a diagram illustrating an example of an overall configuration of a battery exchange system for a vehicle;

FIG. 3 is a diagram illustrating an example of a connection state of an on-board connector to an on-board circuit network;

FIG. 4 is a diagram (side view) illustrating an example of a configuration of a lock mechanism for fixing the main battery to a vehicle frame; and

FIG. 5 is a diagram (plan view) illustrating an example of a configuration of a lock mechanism for fixing the main battery to a vehicle frame.

### DESCRIPTION OF EMBODIMENTS

Hereinafter, preferred embodiments of the present disclosure will be described in detail with reference to the accompanying drawings. In the present specification and drawings, components having substantially the same functions are denoted by the same reference numerals, and redundant descriptions are omitted.

Note that each figure illustrates a common orthogonal coordinate system (X, Y, Z) to clarify the positional relationship of each configuration. The positive direction of the Z-axis represents the vertically upward direction of the vehicle, the positive direction of the X-axis represents the forward direction of the vehicle, and the positive direction of the Y-axis represents the lateral direction of the vehicle.

Hereinafter, an exemplary configuration of a battery exchange system (hereinafter, referred to as “battery exchange system 1”) according to an embodiment of the present invention will be described.

Note that the battery to be exchanged in battery exchange system 1 according to the present embodiment is, for example, mounted on an electric vehicle such as an electric vehicle or a hybrid vehicle and is used as a driving power source for the vehicle (hereinafter, also referred to as a “main battery”).

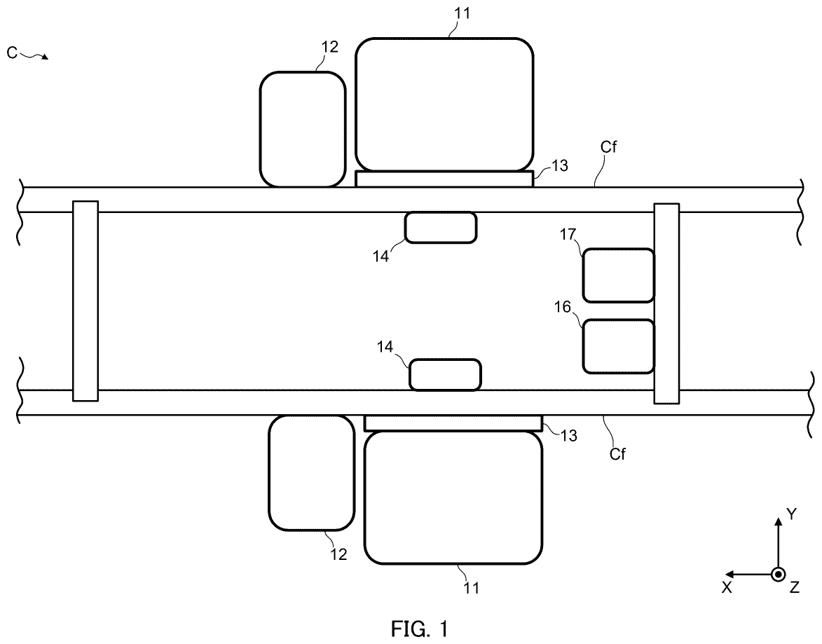

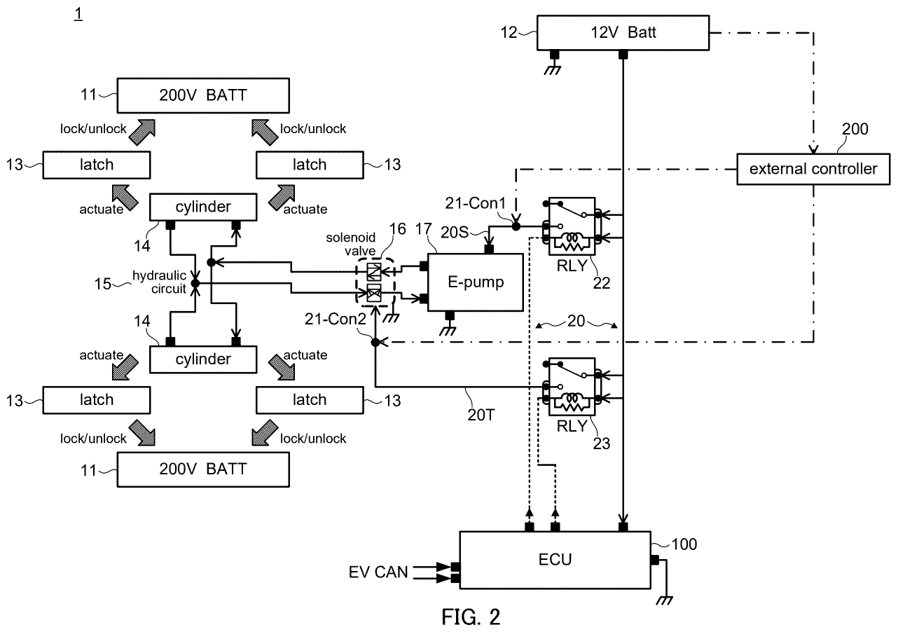

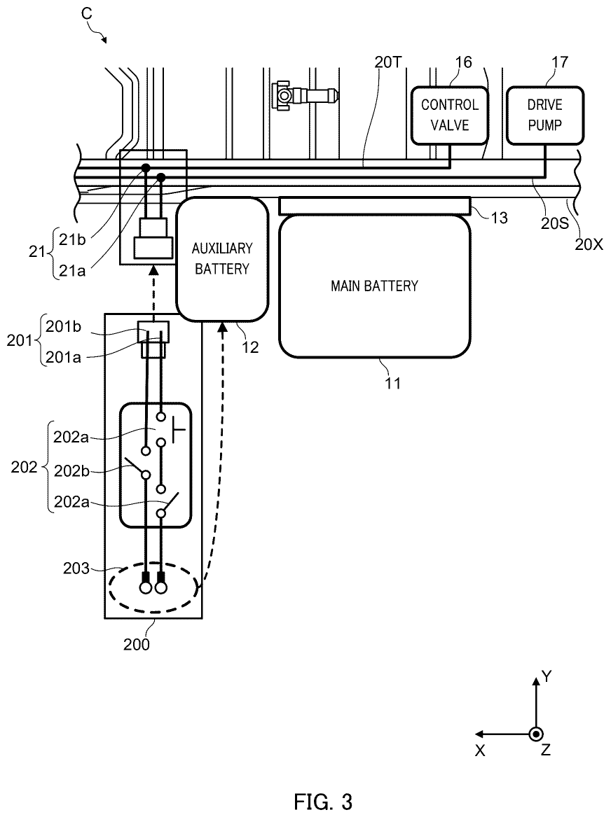

FIG. 1 is a diagram (plan view) illustrating an example of various on-board devices attached to vehicle frame Cf of vehicle C. FIG. 2 is a diagram illustrating an example of an overall configuration of battery exchange system 1 for vehicle C. FIG. 3 is a diagram illustrating an example of a connection state of on-board connector 21 to on-board circuit network 20.

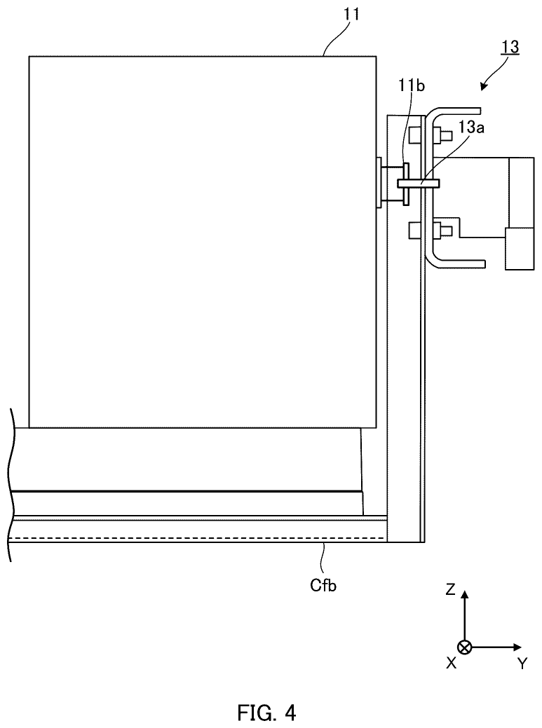

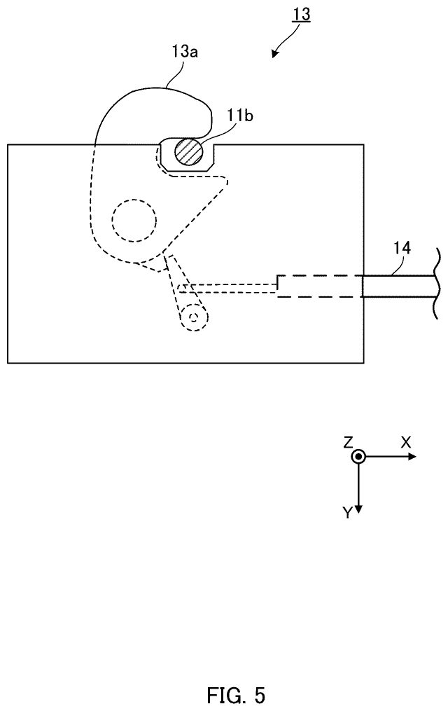

FIGS. 4 and 5 are views illustrating an example of a configuration of lock mechanism 13 that fixes main battery 11 to vehicle frame Cf. FIG. 4 is a side view of lock mechanism 13, and FIG. 5 is a plan view of lock mechanism 13.

Battery exchange system 1 includes main battery 11, auxiliary battery 12, lock mechanism 13, on-board actuator 14, drive mechanism (15, 16, 17) of on-board actuator 14, on-board circuit network 20, on-board connector 21, and on-board controller 100 (see FIG. 2). Note that these are configurations mounted on vehicle C. External controller 200 described in FIG. 2 is configured to be connected to on-board connector 21 in order to allow main battery 11 to be detached from vehicle frame Cf in an emergency or the like.

Vehicle C is a vehicle that can travel using the driving power source of main battery 11, such as an electric vehicle or a hybrid vehicle. FIG. 1 illustrates a configuration of a large vehicle such as a truck as an example.

Vehicle frame Cf of vehicle C extends along the front-rear direction of the vehicle on both the left and right sides of the vehicle, and supports the vehicle body and various on-board devices. Further, wiring and piping for connecting these on-board devices are disposed around vehicle frame Cf. Note that vehicle frame Cf is formed of, for example, a steel member having a U-shaped cross section.

Main battery 11 is a high-voltage battery that supplies operating power for driving vehicle C. Main battery 11 is, for example, a 200 V class lithium-ion battery.

Main battery 11 is supported on mounting table Cfb in vehicle C and fixed to vehicle frame Cf of vehicle C via lock mechanism 13, for example (see FIG. 4). Main battery 11 is typically constituted by a plurality of battery packs attached to vehicle frame Cf via each lock mechanism 13. In the present embodiment, main battery 11 is constituted by two battery packs, and two battery packs are detachable.

Auxiliary battery 12 is a low-voltage battery that supplies operating power to the on-board electrical components. Auxiliary battery 12 is, for example, a 12V lead-acid battery. In the present embodiment, on-board controller 100 and the drive mechanism (drive pump 17 and control valve 16 described later) operate with the power supplied from auxiliary battery 12.

Lock mechanism 13 is fixed to vehicle frame Cf and attaches main battery 11 to vehicle frame Cf. Lock mechanism 13 is constituted by, for example, a latch that is driven by on-board actuator 14 (here, a hydraulic cylinder).

Specifically, lock mechanism 13 is constituted by, for example, latch 13a. Note that, rod-like striker 11b for engaging with latch 13a is attached to battery 11.

Latch 13a is a hook member that is supported rotatably around the Z-axis with respect to a bracket attached to vehicle frame Cf, extended from the inside to the outside (minus Y-direction side) of vehicle frame Cf, and hooked to rod-like striker 11b. Latch 13a rotates around the Z-axis in conjunction with the operation of on-board actuator 14 (here, a hydraulic cylinder). That is, in FIG. 5, when locking main battery 11 to vehicle frame Cf, latch 13a rotates clockwise around the Z-axis, engages with striker 11b attached to battery 11, and fixes main battery 11 to vehicle frame Cf. Further, when releasing the unlocking from vehicle frame Cf of main battery 11, latch 13a rotates counterclockwise around the Z-axis, releases the engaged state with striker 11b, and allows main battery 11 to be removed from vehicle frame Cf.

Typically, when storing main battery 11 in vehicle C, lock mechanism 13 holds a locked state in which main battery 11 is fixed to vehicle frame Cf. Further, when exchanging the battery in main battery 11, lock mechanism 13 releases the locked state of main battery 11 and vehicle frame Cf.

When fixing main battery 11 to vehicle frame Cf, latch 13a needs to pull main battery 11 to the vehicle frame Cf side. For this reason, on-board actuator 14 that drives latch 13a needs a large driving force. From this viewpoint, the present embodiment employs a hydraulic actuator as on-board actuator 14.

On-board actuator 14 drives lock mechanism 13 to perform the attachment/detachment operation of main battery 11 from vehicle frame Cf. The present embodiment uses a hydraulic actuator (here, a hydraulic cylinder) driven by a hydraulic oil medium as on-board actuator 14. The hydraulic actuator is capable of extracting a large torque with a small apparatus, thereby making it possible to stably activate lock mechanism 13 that requires a large torque.

The drive mechanism that drives on-board actuator 14 (here, a hydraulic cylinder) includes hydraulic circuit 15 connected to on-board actuator 14, drive pump 17 that supplies hydraulic oil to hydraulic circuit 15, and control valve 16 disposed in hydraulic circuit 15. Specifically, drive pump 17 sends high-pressure hydraulic oil to hydraulic circuit 15, and control valve 16 controls the supply state of the hydraulic oil to on-board actuator 14. Thus, on-board actuator 14 moves lock mechanism 13 by converting the fluid energy of the hydraulic oil into mechanical energy.

Note that the operation state of on-board actuator 14 is controlled by on-board controller 100. In battery exchange system 1 according to the present embodiment, external controller 200 is connectable to on-board circuit network 20 such that on-board actuator 14 can operate even when on-board controller 100 is in a non-operating state (details will be described later).

On-board circuit network 20 is a circuit network including a control circuit (dashed line arrow in FIG. 2) and a power supply circuit (solid line arrow in FIG. 2) for controlling the operation of on-board actuator 14. On-board circuit network 20 supplies operating power to drive pump 17 and supplies a control signal to control valve 16 under the control of on-board controller 100. Note that, on-board circuit network 20 is constituted by, for example, harness cable 20X attached to vehicle frame Cf.

On-board circuit network 20 according to the present embodiment is connected to auxiliary battery 12, and supplies power to each part by using the power of auxiliary battery 12. Specifically, on-board circuit network 20 includes first line 20S that connects between auxiliary battery 12 and drive pump 17 and supplies operating power to drive pump 17, and second line 20T that connects between auxiliary battery 12 and control valve 16 and supplies a control signal to control valve 16. That is, drive pump 17 receives the supply of operating power via first line 20S and sends high-pressure hydraulic oil to hydraulic circuit 15, thus creating a power source. Further, control valve 16 receives a supply of control signal via second line 20T and controls the supply state to on-board actuator 14, thus controlling the operation state of on-board actuator 14.

First relay 22, which operates with a control signal from on-board controller 100, is disposed in first line 20S. Further, second relay 23, which operates with a control signal from on-board controller 100, is disposed in second line 20T.

That is, in battery exchange system 1 according to the present embodiment, on-board controller 100 controls the operation of drive pump 17 and control valve 16 by controlling the opening/closing states of first relay 22 and second relay 23. Specifically, during the locked state, first relay 22 and second relay 23 are in an open-circuit state and no power is supplied to drive pump 17 and control valve 16 such that drive pump 17 is in a non-operating state and control valve 16 is in a closed state. When transitioning to the unlocking state, first relay 22 and second relay 23 receive a control signal from on-board controller 100, transition to the closed-circuit state, and start supplying power to drive pump 17 and control valve 16, thus driving lock mechanism 13 and unlocking of main battery 11.

On-board controller 100 supplies operating power to a drive mechanism that controls the operation of on-board actuator 14 or transmits a control signal to the drive mechanism via on-board circuit network 20, thereby driving the drive mechanism and controlling the operation of on-board actuator 14. On-board controller 100 is configured to include, for example, a central processing unit (CPU), a read only memory (ROM), a random access memory (RAM), an input port, an output port, a communication module, and the like. Note that, on-board controller 100 is configured to be capable of communicating with the battery exchange station, and, for example, executes the operation control of on-board actuator 14 and activates lock mechanism 13 under the command from the battery exchange station.

Specifically, battery exchange system 1 according to the present embodiment is characterized in that even in a case where on-board controller 100 is in a non-operating state, external controller 200 is connectable to on-board circuit network 20 via on-board connector 21 to activate lock mechanism 13 and enable the exchange or temporary attachment/detachment of main battery 11, and on-board actuator 14 is operable by external controller 200.

On-board connector 21 has one end connected to on-board circuit network 20 and the other end to which external controller 200 can be connected (see FIG. 3). Specifically, on one end side, on-board connector 21 includes first terminal 21a connected to first line 20S directly connected to drive pump 17 of on-board circuit network 20, and second terminal 21b connected to second line 20T directly connected to control valve 16. On the other end side, on-board connector 21 is connected to third terminal 201a and fourth terminal 201b of external controller 200 at first terminal 21a and second terminal 21b, respectively.

The connection position of on-board connector 21 to on-board circuit network 20 is, for example, on the downstream side of first relay 22 and second relay 23 as viewed from auxiliary battery 12. That is, first terminal 21a of on-board connector 21 is connected to the downstream side of first relay 22 in first line 20S, which is directly connected to drive pump 17 (21-Con1 in FIG. 2). Further, second terminal 21b of on-board connector 21 is connected to the downstream side of second relay 23 in second line 20T, which is directly connected to control valve 16 (21-Con2 in FIG. 2). When on-board controller 100 is in a non-operating state, first relay 22 and second relay 23 are also in a non-operating state, and first relay 22 and second relay 23 are in a closed-circuit state. From this viewpoint, the connection position of on-board connector 21 is set to such a position that drive pump 17 and control valve 16 are operated with direct power supply from external controller 200.

Note that a cap for covering the connection terminal is provided at the other end of on-board connector 21 (the side connected to external controller 200) (not illustrated). The reason for this is to ensure the insulation of first terminal 21a and second terminal 21b of on-board connector 21 when external controller 200 is in a non-connected state. That is, in a normal state, power from auxiliary battery 12 is supplied to the connection terminal of on-board connector 21, and accidental contact by a worker with the connection terminal results in leakage current.

External controller 200 is a controller that is connected to on-board connector 21 to control the operation of on-board actuator 14 when on-board controller 100 is in a non-operating state. Specifically, external controller 200 controls the operation of on-board actuator 14 by supplying operating power to drive pump 17 and supplying a control signal to control valve 16 via on-board circuit network 20.

More specifically, as described above, external controller 200 includes connection terminal 201 including third terminal 201a and fourth terminal 201b on one end side. When external controller 200 is attached to on-board connector 21, third terminal 201a is connected to first terminal 21a of on-board connector 21, and fourth terminal 201b is connected to second terminal 21b of on-board connector 21.

Further, external controller 200 includes, on the other end side, power receiving connector 203 that is connectable to an external power source different from main battery 11, and supplies the power received from the external power source via power receiving connector 203 to on-board circuit network 20 via on-board connector 21 (see FIG. 3). That is, external controller 200 is capable of supplying the operating power to first line 20S (that is, drive pump 17) and supplying the control signal to second line 20T (that is, control valve 16) by using the power received from the external power source (one-dot chain line arrows in FIG. 2).

Note that, preferably, auxiliary battery 12 mounted on vehicle C is connectable to power receiving connector 203 of external controller 200 as an external power source. Thus, when operating on-board actuator 14 with external controller 200, there is no need to prepare another external power source outside the vehicle, which is convenient. Note that, from this viewpoint, it is preferable that on-board connector 21 is disposed at a position close to auxiliary battery 12.

Note that, another external power source different from auxiliary battery 12 may be connectable to power receiving connector 203 of external controller 200.

Further, external controller 200 includes operation part 202 that receives an operation from a user. Operation part 202 includes first switch 202a that switches the supply state of the operating power from external controller 200 to first line 20S (that is, drive pump 17), and second switch 202b that switches the supply state of the control signal from external controller 200 to second line 20T (that is, control valve 16).

Note that first switch 202a may be constituted by two types of switches, a relay switch and a push button switch, as illustrated in FIG. 3, in order to make it possible to adjust the driving force of drive pump 17. With such a configuration, by adjusting the ON-time of the push button switch, the user can control the amount of power supplied to drive pump 17 and can adjust the driving force of drive pump 17 (that is, the driving force of on-board actuator 14).

### Unlocking Work of Lock Mechanism 13 Using External Controller 200

Now, a work of unlocking lock mechanism 13 using external controller 200 when on-board controller 100 is in a non-operating state will be described.

In battery exchange system 1 according to the present embodiment, during normal operation (that is, when the battery is not being exchanged), lock mechanism 13 is held in a locked state, and first relay 22 and second relay 23 are in an open-circuit state. For this reason, when on-board controller 100 is in a non-operating state, it is not possible to supply the operating power to drive pump 17 and the control signal to control valve 16. Therefore, in order to perform the attachment/detachment operation of main battery 11 from vehicle frame Cf when on-board controller 100 is in a non-operating state, it is necessary to use external controller 200 to drive lock mechanism 13.

First, the worker prepares external controller 200. Then, the worker connects connection terminal 201 of external controller 200 to on-board connector 21. Next, the worker connects power receiving connector 203 of external controller 200 to auxiliary battery 12.

Next, the worker operates operation part 202 of external controller 200 to switch first switch 202a and second switch 202b to the on state.

Thus, with external controller 200, the supply of the operating power to first line 20S (that is, drive pump 17) and the supply of the control signal to second line 20T (that is, control valve 16) are started by using the power received from auxiliary battery 12. Thus, drive pump 17 starts driving and control valve 16 changes to the opened state, and that the high-pressure hydraulic oil delivered by drive pump 17 to hydraulic circuit 15 is supplied to on-board actuator 14. Thus, on-board actuator 14 moves lock mechanism 13 to unlock lock mechanism 13.

Through the above-described work, it is possible to remove main battery 11 from vehicle frame Cf.

When attaching main battery 11 to vehicle frame Cf, the worker may operate on-board actuator 14 with external controller 200 in a state where main battery 11 is placed on the battery mounting table of vehicle C, and perform the locking operation of lock mechanism 13.

### Effects

As described above, battery exchange system 1 for electric vehicle C according to the present embodiment includes:
lock mechanism 13 that is fixed to vehicle frame Cf of vehicle C and attaches battery 11 to vehicle frame Cf;
on-board actuator 14 that drives lock mechanism 13 and switches between a locked state and an unlocked state of battery 11 with respect to vehicle frame Cf;
on-board circuit network 20 for operating on-board actuator 14;
on-board controller 100 that controls the operation of on-board actuator 14 via on-board circuit network 20; and
on-board connector 21, one end of which is connected to on-board circuit network 20 and the other end of which is connectable to external controller 200, in which
when on-board controller 100 is in a non-operating state, the operation of on-board actuator 14 is controllable by external controller 200 via on-board circuit network 20.

According to battery exchange system 1 of the present embodiment, even when on-board controller 100 is in a non-operating state, it is possible to activate lock mechanism 13 and remove or attach battery 11 from or to vehicle frame Cf by using external controller 200.

That is, it is possible to exchange battery 11 or temporarily attach/detach battery 11 in an emergency even at a location other than the battery exchange station. Further, in the vehicle development phase, there are many stages in which on-board controller 100 is in a non-operating state, but even in such stages, it is possible to remove and attach battery 11 from vehicle C, contributing to the improvement of workability during vehicle development.

In particular, in battery exchange system 1 according to the present embodiment, both the operating power and the control signal for operating on-board actuator 14 can be supplied to on-board circuit network 20 using external controller 200. Thus, it is useful in that no other complicated electrical control is required.

The present invention is not limited to the above-described embodiments, and can be applied to various modifications.

For example, a hydraulic actuator is used as an example of on-board actuator 14 in the above embodiment. However, an electric actuator may be used as on-board actuator 14 in the present invention.

Further, a latch mechanism is described as an example of lock mechanism 13 in the above embodiment. However, lock mechanism 13 used in the present invention is optional, and another lock mechanism may be used.

While the present invention has been described above in detail with reference to specific embodiments, these embodiments are presented by way of example and are not intended to limit the scope of the invention. The technology described in the claims includes various modifications and variations of the specific examples illustrated above.

This application is entitled to and claims the benefit of Japanese Patent Application No. 2024-73911 filed on Apr. 30, 2024, the disclosure each of which including the specification, drawings and abstract is incorporated herein by reference in its entirety.

### INDUSTRIAL APPLICABILITY

According to the battery exchange system of the present invention, it is possible to activate the lock mechanism and attach/detach the battery even when the on-board controller is in a non-operating state.

### REFERENCE SIGNS LIST

1 Battery exchange system
11 Main battery
11b Striker
12 Auxiliary battery
13 Lock mechanism
14 On-board actuator
15 Hydraulic circuit
16 Control valve
17 Drive pump
20 On-board circuit network
20S First line
20T Second line
20X Harness cable
21 On-board connector
22 First relay
23 Second relay
100 On-board controller
200 External controller
201 Connection terminal
202 Operation part
203 Power receiving connector
C Vehicle
Cf Vehicle frame

1. A battery exchange system for an electric vehicle, the battery exchange system comprising:
a lock mechanism fixed to a vehicle frame of the electric vehicle and configured to attach a battery to the vehicle frame;
an on-board actuator configured to drive the lock mechanism to switch between a locked state and an unlocked state of the battery with respect to the vehicle frame;
an on-board circuit network configured to operate the on-board actuator;
an on-board controller configured to control an operation of the on-board actuator via the on-board circuit network; and
an on-board connector, one end of which is connected to the on-board circuit network and the other end of which is connectable to an external controller, wherein
when the on-board controller is in a non-operating state, the operation of the on-board actuator is controllable by the external controller via the on-board circuit network.

2. The battery exchange system according to claim 1,
wherein the on-board actuator is a hydraulic actuator; and
wherein the operation of the on-board actuator is controlled by an activation of a drive mechanism including a hydraulic circuit connected to the on-board actuator, a drive pump configured to supply hydraulic oil to the hydraulic circuit, and a control valve disposed in the hydraulic circuit.

3. The battery exchange system according to claim 2, wherein the on-board connector is connected to each of a first line configured to supply power to the drive pump and a second line configured to supply power to the control valve in the on-board circuit network.

4. The battery exchange system according to claim 3,
wherein the external controller includes an operation part configured to receive an operation from a user; and
wherein the operation part includes a first switch configured to control a power supply state to the first line and a second switch configured to control a power supply state to the second line.

5. The battery exchange system according to claim 1,
wherein the external controller includes a power receiving connector connectable to a second power source different from the battery; and
wherein the external controller uses power received from the second power source to supply operating power for operating the on-board actuator via the on-board circuit network.

6. The battery exchange system according to claim 5, wherein the second power source is an auxiliary battery mounted on the electric vehicle.

7. The battery exchange system according to claim 1, wherein the on-board connector includes a cap configured to cover a terminal configured to connect the external controller.
